(19) United States
(12) Patent Application Publication
(10) Pub. No.: US 2010/0034919 A1
(43) Pub. Date: Feb. 11, 2010

(54) Melt Processible Semicrystalline Fluoropolymer having Repeating Units Arising from Tetrafluoroethylene, Hexafluoropropylene, and Hydrocarbon Monomer Having a Carboxyl Group and a Polymerizable Carbon-Carbon Double Bond and Multi-Layer Articles Comprising a Layer of the Melt Processible Semicrystalline Fluoropolymer

(75) Inventors: Paul Douglas Brothers, Chadds Ford, PA (US); Sharon Ann Libert, Hockessin, DE (US); Ralph Munson Aten, Chadds Ford, PA (US); Paul P. Cheng, Parkersburg, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/512,276

(22) Filed: Jul. 30, 2009

Related U.S. Application Data
(60) Provisional application No. 61/087,359, filed on Aug. 8, 2008.
(60) Provisional application No. 61/087,384, filed on Aug. 8, 2008.
(60) Provisional application No. 61/087,369, filed on Aug. 8, 2008.

(51) Int. Cl. B32B 27/06; B32B 27/36; B32B 15/08; B29C 47/12

(52) U.S. Cl. 425/461; 428/421; 428/412; 428/379; 428/375

(57) ABSTRACT

Disclosed is a melt processible semicrystalline fluoropolymer comprising: (a) about 2 to about 20 weight percent of repeating units arising from hexafluoropropylene; (b) about 0.001 to about 1 weight percent of repeating units arising from a hydrocarbon monomer having a carboxyl group and a polymerizable carbon-carbon double bond; and (c) the remaining weight percent of repeating units arising from tetrafluoroethylene. This melt processible semicrystalline fluoropolymer is impermeable to fuels and is useful as a lining for petroleum fuel tubing, as well as chemical resistance coating for, or adhesive between, perfluoropolymer and other polymers, metals and inorganics.

### BACKGROUND INFORMATION

1. Field of the Disclosure

This disclosure relates in general to a melt processible semicrystalline fluoropolymer having repeating units arising from tetrafluoroethylene, hexafluoropropylene, and a hydrocarbon monomer having a carboxyl group and a polymerizable carbon-carbon double bond, and multi-layer articles comprising a layer of the melt processible semicrystalline fluoropolymer.

2. Description of the Related Art

Fluorine containing polymers are important commercial products due to their low surface energy and high thermal and chemical resistance. However, their low surface energy often leads to poor adhesion to substrates.

Certain functional groups are known to modify the adhesive properties of partially fluorinated polymers. Incorporation of such groups during polymerization of partially fluorinated polymers without significantly sacrificing desirable polymer properties has been met with limited success to date. Monomers containing functional groups may not copolymerize with fluorinated monomers or may cause other undesirable effects in a copolymerization. Further, incorporation of monomers containing functional groups can adversely affect the thermal stability or chemical resistance of the resulting polymer.

Thus, there is a need for thermally stable and chemically resistant fluorine containing polymers that also have adhesive properties.

Partially fluorinated polymer coatings can be formed on metal substrates by known processes wherein a metal surface is roughened and a primer is coated, followed by particles of a partially fluorinated polymer being deposited thereon and then melted. Such metal roughening and use of primer adds complexity and cost to an industrial process.

Thus, there is a need for thermally and chemically resistant fluoropolymers that also have adhesive properties to metals without requiring primers or metal surface roughening.

One commercial method involves subjecting a fluoropolymer tube to surface treatment by a chemical reagent, corona discharge treatment or plasma discharge treatment, often followed by coating with an adhesive. Non-fluorinated polymer such as polyamide is then extruded onto the outer surface of the so-modified fluoropolymer tube. Such an adhering method adds complexity and cost to, and reduces the productivity of, this industrial process.

Thus, there is a need for a fluoropolymer which does not require such surface treatment and whereby it is possible to form at reasonable processing temperatures a multi-layer article with non-fluorinated polymer by melt processing methodology such as coextrusion.

Multilayer articles having layers of non-fluorinated polymers and fluorinated polymers benefit from fluorinated polymer characteristics, such as thermal resistance and chemical impermeability, as well as non-fluorinated polymer characteristics, such as high strength, high toughness, light weight, good processibility, flexibility and affordability. Multilayer articles having layers of fluorinated polymers and polyamides find use in fuel service in devices powered by internal combustion engines. In such articles, it is necessary that adjacent layers of fluorinated polymer and polyamide are adhered to one other.

However, multilayer articles having layers of non-fluorinated polymers and fluorinated polymers generally suffer from low interfacial adhesion, which can lead to delamination and structural failure upon use.

Attempts have been made to strengthen interlayer adhesion in such articles by blending. In the instance where the adhesion of fluorinated polymer and polyamide is desired, blends of polyamide and fluorinated polymer have been disclosed as adhesive. However, in this approach the morphology of the adhesive changes according to the molding conditions due to the intrinsically poor compatibility between the constituent resins in the blend. The morphology change also negatively influences the cohesive strength of the adhesive layer itself and the adhesion thereto with other layers. Additionally, this technology does not increase the adhesiveness of the fluorinated polymer itself but merely utilizes the adhesiveness of the blend. The use of such polymer blend results in an impairment of the desirable characteristics of the fluorinated polymer.

Attempts have been made to strengthen interlayer adhesion in such articles by modifying the fluorinated polymer. In the instance where the adhesion of fluorinated polymer and polyamide is desired, fluorinated polymer has been modified, for example by grafting or copolymerization, to contain acid anhydride groups. However, in these approaches, the modified fluorinated polymers suffer from a variety of shortcomings, for example: lack of melt processibility at temperatures required for melt processing the polyamide; lacking a crystalline melting point and having an amorphous and elastomeric nature unsuitable for melt processing techniques such as coextrusion; or the modified fluorinated polymers containing a relatively high amount of acid anhydride groups and suffering from thermal instability and reduced chemical impermeability.

Thus, there is a need for multilayer articles having layers of non-fluorinated polymers and fluorinated polymers where: (1) the non-fluorinated polymer and the fluorinated polymer are strongly adhered to one another; (2) the articles are easily formed by conventional melt processing methodology such as coextrusion; and (3) the articles have fluorinated polymer characteristics, such as thermal resistance and chemical impermeability, as well as non-fluorinated polymer characteristics, such as high strength, high toughness, light weight, good processibility, flexibility and affordability.

### SUMMARY

Melt processible semicrystalline fluoropolymer is described herein that meets industry needs by strongly adhering to a variety of substrates, by being melt processible under reasonable processing conditions using conventional methodology, and by having thermal and chemical resistance of utility in a range of commercial applications.

Described herein is a melt processible semicrystalline fluoropolymer comprising: (a) about 2 to about 20 weight percent of repeating units arising from hexafluoropropylene (also referred to herein as HFP); (b) about 0.001 to about 1 weight percent of repeating units arising from a hydrocarbon monomer having a carboxyl group and a polymerizable carbon-carbon double bond (also referred to herein as a functional group monomer or FG); and (c) the remaining weight percent of repeating units arising from tetrafluoroethylene (also referred to herein as TFE).

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts presented herein.

FIG. 1 illustrates a cross-sectional view of a present multilayer article having two layers.

FIG. 2 illustrates a cross-sectional view of a present multilayer article having three layers.

FIG. 3 illustrates a cross-sectional view of a present multilayer tube having two layers.

FIG. 4 illustrates a cross-sectional view of a present multilayer tube having three layers.

Skilled artisans appreciate that objects in the figures are illustrated for simplicity and clarity and have not been drawn to scale. The dimensions of some of the layers in the figures are exaggerated relative to other layers to help to improve understanding.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION

In one embodiment of the melt processible semicrystalline fluoropolymer, the melt processible semicrystalline fluoropolymer comprises: (a) about 2 to about 20 weight percent of repeating units arising from hexafluoropropylene; (b) about 0.001 to about 1 weight percent of repeating units arising from a hydrocarbon monomer having a carboxyl group and a polymerizable carbon-carbon double bond; (c) about 0.5 to about 10 weight percent of repeating units arising from perfluoro(alkyl vinyl ether); and (d) the remaining weight percent of repeating units arising from tetrafluoroethylene; wherein the sum of the weight percent of repeating units arising from hexafluoropropylene and weight percent of repeating units arising from perfluoro(alkyl vinyl ether) is greater than about 4 weight percent and less than about 20 weight percent.

In another embodiment the melt processible semicrystalline fluoropolymer comprises: (a) about 4 to about 14 weight percent of repeating units arising from hexafluoropropylene; (b) about 0.001 to about 1 weight percent of repeating units arising from a hydrocarbon monomer having a carboxyl group and a polymerizable carbon-carbon double bond and containing a dicarboxylic acid anhydride group or a dicarboxylic acid group; (c) about 0.5 to about 3 weight percent of repeating units arising from perfluoro(alkyl vinyl ether); and (d) the remaining weight percent of repeating units arising from tetrafluoroethylene.

In another embodiment, described herein is a melt-blended mixture comprising a polymer and a melt processible semicrystalline fluoropolymer, wherein the melt processible semicrystalline fluoropolymer comprises: (a) about 2 to about 20 weight percent of repeating units arising from hexafluoropropylene; (b) from about 0.001 to about 1 weight percent of repeating units arising from a hydrocarbon monomer having a carboxyl group and a polymerizable carbon-carbon double bond; and (c) the remaining weight percent of repeating units arising from tetrafluoroethylene.

In another embodiment, described herein is a multi-layer article having a layer comprising a melt processible semicrystalline fluoropolymer, wherein said melt processible semicrystalline fluoropolymer comprises: (a) about 2 to about 20 weight percent of repeating units arising from hexafluoropropylene; (b) from about 0.001 to about 1 weight percent of repeating units arising from a hydrocarbon monomer having a carboxyl group and a polymerizable carbon-carbon double bond; and (c) the remaining weight percent of repeating units arising from tetrafluoroethylene.

In another embodiment, described herein is a multi-layer article comprising: (A) a first layer comprising at least one material selected from the group consisting of non-fluorinated polymer having polar functionality, metal and inorganic, and; (B) a second layer comprising a melt processible semicrystalline fluoropolymer, wherein the melt processible semicrystalline fluoropolymer comprises: (a) about 2 to about 20 weight percent of repeating units arising from hexafluoropropylene; (b) about 0.001 to about 1 weight percent of repeating units arising from a hydrocarbon monomer having a carboxyl group and a polymerizable carbon-carbon double bond; and (c) the remaining weight percent of repeating units arising from tetrafluoroethylene, wherein (A) and (B) are in contiguous contact.

Embodiments described above are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses 1. Definitions and Clarification of Terms followed by: 2. Perfluoromonomer; 3. Functional Group Monomer (FG); 4. FG-fluoropolymer Melting Point and Melt Flow Rate; 5. FG-fluoropolymer Fluorine Content; 6. FG-fluoropolymer Fuel Vapor Transmission Rate; 7. FG-fluoropolymer Comprising Perfluoromonomer and FG; 8. FG-fluoropolymer Comprising TFE, HFP and FG; 9. FG-fluoropolymer Comprising TFE, HFP, PAVE and FG; 10. Optional Monomers; 11. Process for the Manufacture of FG-fluoropolymer; 12. FG-fluoropolymer Utility; 13. Multi-Layer Article; 14. Multi-Layer Article First Layer (A)—Non-Fluorinated Polymer Having Polar Functionality; 15. Multi-Layer Article First Layer (A)—Thermoplastic Having Amine Functionality; 16. Multi-Layer Article First Layer (A)—Metal; 17. Multi-Layer Article First Layer (A)—Inorganic; 18. Multi-Layer Article Optional Third Layer (B1)—Perfluoropolymer; 19. Thickness Of Multi-Layer Article Layers; 20. Method Of Manufacture Of Multi-Layer Article; and Examples.

### 1. Definitions and Clarifications of Terms

Before addressing details of embodiments described below, some terms are defined or clarified.

By semicrystalline is meant that the melt processible semicrystalline fluoropolymers have some crystallinity and are characterized by a detectable melting point measured according to ASTM D 4501, and a melting endotherm of at least about 3 J/g. Semicrystalline fluoropolymers are distinguished from amorphous fluoropolymers.

By melt processible is meant that the polymer can be processed using conventional plastic processing techniques, such as melt extrusion.

Melt processible semicrystalline fluoropolymer described herein as comprising (a) about 2 to about 20 weight percent of repeating units arising from hexafluoropropylene, (b) about 0.001 to about 1 weight percent of repeating units arising from a hydrocarbon monomer having a carboxyl group and a polymerizable carbon-carbon double bond, and (c) the remaining weight percent of repeating units arising from tetrafluoroethylene, is alternately referred to herein as “FG-fluoropolymer.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which the claims belong. Although methods and materials similar or equivalent to those described herein can be used in the practice or testing of the embodiments disclosed, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials and processing acts are conventional and may be found in textbooks and other sources within the polymer art.

### 2. Perfluoromonomer

Perfluoromonomer is defined herein as compounds containing the elements carbon and fluorine and carbon-carbon unsaturation. All monovalent atoms bonded to carbon in the perfluoromonomer are fluorine. In one embodiment, perfluoromonomer further contains at least one heteroatom selected from the group consisting of oxygen, sulfur and nitrogen.

In one embodiment, perfluoromonomers of utility include perfluoroalkenes and perfluorinated vinyl ethers having 2 to 8 carbon atoms. In another embodiment, perfluorinated vinyl ethers are represented by the formula CF₂═CFOR or CF₂═CFOR′OR, wherein R is perfluorinated linear or branched alkyl groups containing 1 to 5 carbon atoms, and R′ is perfluorinated linear or branched alkylene groups containing 1 to 5 carbon atoms. In another embodiment, R groups contain 1 to 4 carbon atoms. In another embodiment, R′ groups contain 2 to 4 carbon atoms.

Example perfluoromonomers include tetrafluoroethylene (TFE), hexafluoropropylene (HFP), perfluoro-2,2-dimethyl-1,3-dioxole (PDD), perfluoro-2-methylene-4-methyl-1,3-dioxolane (PMD), perfluoro-3,6-dioxa-4-methyl-7-octenesulfonyl fluoride (PSEPVE) and perfluoro(alkyl vinyl ethers) (PAVE) such as perfluoro(methyl vinyl ether) (PMVE), perfluoro(ethyl vinyl ether) (PEVE), perfluoro(propyl vinyl ether) (PPVE), and perfluoro(butyl vinyl ether) (PBVE).

In one embodiment, melt processible semicrystalline fluoropolymer comprises repeating units arising from perfluoromonomer and functional group monomer and is perfluorinated except for repeating units arising from functional group monomer.

### 3. Functional Group Monomer (FG)

Functional group monomer (FG) contains a carboxyl group (—C(═O)O—) and a polymerizable carbon-carbon double bond. FG contains no fluorine.

In one embodiment, FG contains a dicarboxylic acid anhydride group (—C(═O)OC(═O)—) and a polymerizable double bond.

In another embodiment, FG contains a dicarboxylic acid group and a polymerizable double bond. In another embodiment, FG contains a 1,2- or 1,3-dicarboxylic acid group and a polymerizable carbon-carbon double bond.

In another embodiment, FG includes C₄ to C₁₀ dicarboxylic acids and dicarboxylic acid anhydrides containing a polymerizable carbon-carbon double bond. For example: maleic anhydride, dichloromaleic anhydride, maleic acid, fumaric acid, itaconic anhydride, itaconic acid, citraconic anhydride, citraconic acid, mesaconic acid, 5-norbornene-2,3-dicarboxylic anhydride and 5-norbornene-2,3-dicarboxylic acid.

In one embodiment, FG-fluoropolymer comprises about 0.001 to about 1 weight percent of repeating units arising from FG. In another embodiment, FG-fluoropolymer comprises about 0.001 to about 0.5 weight percent of repeating units arising from FG. In another embodiment, FG-fluoropolymer comprises about 0.001 to about 0.3 weight percent of repeating units arising from FG. In another embodiment, FG-fluoropolymer comprises about 0.001 to about 0.1 weight percent of repeating units arising from FG. In another embodiment, FG-fluoropolymer comprises about 0.001 to about 0.01 weight percent of repeating units arising from FG.

### 4. FG-Fluoropolymer Melting Point and Melt Flow Rate

The FG-fluoropolymer melting point can be determined by ASTM method D 4591-01, “Standard Test Method for Determining Temperatures and Heats of Transitions of Fluoropolymers by Differential Scanning Calorimetry.”

In one embodiment, the FG-fluoropolymer melting point is below about 265° C. In another embodiment, the FG-fluoropolymer melting point is below about 260° C. In another embodiment, the FG-fluoropolymer melting point is below about 250° C. In another embodiment, the FG-fluoropolymer melting point is below about 240° C. In another embodiment, the melting point of the FG-fluoropolymer is below about 230° C. In another embodiment, the melting point of the FG-fluoropolymer is below about 225° C. In another embodiment, the melting point of the FG-fluoropolymer is below about 220° C.

The FG-fluoropolymer melt flow rate (MFR) can be determined by ASTM method D1238-04c. FG-fluoropolymer MFR can be tailored to a value of specific utility, e.g., to be similar to the MFR of another polymer that FG-fluoropolymer is to be coextruded with.

In one embodiment, the MFR of FG-fluoropolymer is about 1 to about 400 g/10 minutes. In another embodiment, the MFR of FG-fluoropolymer is about 10 to about 300 g/10 minutes. In another embodiment, the MFR of FG-fluoropolymer is about 1 to about 100 g/10 minutes. In another embodiment, the MFR of FG-fluoropolymer is about 20 to about 90 g/10 minutes. In another embodiment, the MFR of FG-fluoropolymer is about 1 to about 50 g/10 minutes. In another embodiment, the MFR of FG-fluoropolymer is about 5 to about 40 g/10 minutes. In another embodiment, the MFR of FG-fluoropolymer is about 10 to about 30 g/10 minutes. In another embodiment, the MFR of FG-fluoropolymer is about 15 to about 30 g/10 minute. In another embodiment, the MFR of FG-fluoropolymer is about 20 to about 30 g/10 minutes.

### 5. FG-Fluoropolymer Fluorine Content

FG-fluoropolymer fluorine content can be determined by mass balance based on the amount of monomer consumed in the polymerization process used to make the FG-fluoropolymer. In one embodiment, FG-fluoropolymer fluorine content is at least about 65 weight percent. In another embodiment, FG-fluoropolymer fluorine content is at least about 70 weight percent. In another embodiment, FG-fluoropolymer fluorine content is at least about 75 weight percent.

### 6. FG-Fluoropolymer Fuel Vapor Transmission Rate

FG-fluoropolymer resists permeation by liquid fuels and liquid petroleum products such as gasoline, CE10 (mixture of 10 volume percent ethanol and the remainder gasoline (10 wt % ethanol, 45 wt % iso-octane, 45 wt % toluene)), CE85 (mixture of 85 volume percent ethanol and the remainder gasoline), diesel fuel, heating oil, biofuel, and biodiesel. FG-fluoropolymer also resists permeation by industrial solvents such as alcohols, ketones, and esters.

In one embodiment, the CE10 fuel vapor transmission rate at 40° C. as measured by the procedure described in SAE J2659-03 is not greater than about 0.1 g·mm/m²·day. In another embodiment, the CE10 fuel vapor transmission rate at 40° C. as measured by the procedure described in SAE J2659-03 is not greater than about 0.05 g·mm/m²·day. In another embodiment, the CE10 fuel vapor transmission rate at 40° C. as measured by the procedure described in SAE J2659-03 is not greater than about 0.04 g·mm/m²·day.

### 7. FG-Fluoropolymer Comprising Perfluoromonomer and FG

In one embodiment, melt processible semicrystalline fluoropolymer comprises repeating units arising from: (a) a perfluoromonomer; and (b) about 0.001 to about 1 weight percent of FG; wherein said melt processible semicrystalline fluoropolymer has a melting point below about 265° C. and a fluorine content of at least about 69 weight percent.

### 8. FG-Fluoropolymer Comprising TFE, HFP and FG

In one embodiment, melt processible semicrystalline fluoropolymer comprises: (a) about 2 to about 20 weight percent of repeating units arising from HFP; (b) about 0.001 to about 1 weight percent of repeating units arising from FG; and (c) the remaining weight percent of repeating units arising from TFE. In another embodiment, the FG-fluoropolymer comprising TFE, HFP and FG comprises about 4 to about 20 weight percent of repeating units arising from HFP. In another embodiment, the FG-fluoropolymer comprising TFE, HFP and FG comprises about 4 to about 14 weight percent of repeating units arising from HFP. In another embodiment, the FG-fluoropolymer comprising TFE, HFP and FG comprises about 8 to about 12 weight percent of repeating units arising from HFP. In another embodiment, the FG-fluoropolymer comprising TFE, HFP and FG comprises about 10 to about 12 weight percent of repeating units arising from HFP.

Various embodiments of the amount of repeating units arising from FG in the FG-fluoropolymer comprising TFE, HFP and FG are contemplated, and are described earlier herein at section 3. Functional Group Monomer (FG).

### 9. FG-Fluoropolymer Comprising TFE, HFP, PAVE and FG

In one embodiment, melt processible semicrystalline fluoropolymer further comprises repeating units arising from perfluoro(alkyl vinyl ether) (PAVE).

In another embodiment, melt processible semicrystalline fluoropolymer comprises: (a) about 2 to about 20 weight percent of repeating units arising from HFP; (b) about 0.001 to about 1 weight percent of repeating units arising from FG; (c) about 0.5 to about 10 weight percent of repeating units arising from PAVE; and (d) the remaining weight percent of repeating units arising from TFE; wherein the sum of the weight percent of repeating units arising from HFP and weight percent of repeating units arising from PAVE is greater than about 4 weight percent and less than about 20 weight percent.

In another embodiment, the FG-fluoropolymer comprising TFE, HFP, PAVE and FG comprises about 4 to about 20 weight percent of repeating units arising from HFP. In another embodiment, the FG-fluoropolymer comprising TFE, HFP, PAVE and FG comprises about 4 to about 16 weight percent of repeating units arising from HFP. In another embodiment, the FG-fluoropolymer comprising TFE, HFP, PAVE and FG comprises about 8 to about 16 weight percent of repeating units arising from HFP. In another embodiment, the FG-fluoropolymer comprising TFE, HFP, PAVE and FG comprises about 9 to about 14 weight percent of repeating units arising from HFP.

In another embodiment, the FG-fluoropolymer comprising TFE, HFP, PAVE and FG comprises about 0.5 to about 3 weight percent of repeating units arising from PAVE. In another embodiment, the FG-fluoropolymer comprising TFE, HFP, PAVE and FG comprises about 1 to about 10 weight percent of repeating units arising from PAVE. In another embodiment, the FG-fluoropolymer comprising TFE, HFP, PAVE and FG comprises about 2 to about 8 weight percent of repeating units arising from PAVE. In another embodiment, the FG-fluoropolymer comprising TFE, HFP, PAVE and FG comprises about 3 to about 7 weight percent of repeating units arising from PAVE.

Various embodiments of the amount of repeating units arising from FG in the TFE/HFP/PAVE/FG melt processible semicrystalline fluoropolymer are contemplated, and are described earlier herein at section 3. Functional Group Monomer (FG).

In another embodiment, the FG-fluoropolymer comprising TFE, HFP, PAVE and FG comprises: (a) about 12 weight percent of repeating units arising from HFP; (b) about 0.01 to about 0.1 weight percent of repeating units arising from FG; (c) and about 0.75 weight percent of repeating units arising from PAVE; and (d) the remaining weight percent of repeating units arising from TFE.

In another embodiment, the FG-fluoropolymer comprising TFE, HFP, PAVE and FG comprises: (a) about 12 weight percent of repeating units arising from HFP; (b) about 0.01 to about 0.1 weight percent of repeating units arising from FG; (c) and about 1.5 weight percent of repeating units arising from PAVE; and (d) the remaining weight percent of repeating units arising from TFE.

In another embodiment, the FG-fluoropolymer comprising TFE, HFP, PAVE and FG comprises: (a) about 6 weight percent of repeating units arising from HFP; (b) about 0.01 to about 0.1 weight percent of repeating units arising from FG; (c) and about 2 weight percent of repeating units arising from PAVE; and (d) the remaining weight percent of repeating units arising from TFE.

In another embodiment, the FG-fluoropolymer comprising TFE, HFP, PAVE and FG comprises: (a) about 5 weight percent of repeating units arising from HFP; (b) about 0.01 to about 0.1 weight percent of repeating units arising from FG; (c) and about 5 weight percent of repeating units arising from PAVE; and (d) the remaining weight percent of repeating units arising from TFE.

In another embodiment, the FG-fluoropolymer comprising TFE, HFP, PAVE and FG comprises: (a) about 5 to about 6 weight percent of repeating units arising from HFP; (b) about 0.01 to about 0.1 weight percent of repeating units arising from FG; (c) and about 6 to about 7 weight percent of repeating units arising from perfluoro(methyl vinyl ether); and (d) about 86 to about 89 weight percent of repeating units arising from TFE.

### 10. Optional Monomers

In one embodiment, FG-fluoropolymer optionally contains repeating units arising from a non-perfluorinated monomer such as ethylene, propylene, vinylidene fluoride, vinyl fluoride, chlorotrifluoroethylene and methyl perfluoro-4,7-dioxa-5-methyl -8-nonenoate (EVE). If repeating units arising from such non-perfluorinated monomers are included in the FG-fluoropolymer, they are present at a low level that does not reduce the fuel permeation resistance and/or other beneficial (e.g., adhesion) properties of the FG-fluoropolymer.

In one embodiment, the FG-fluoropolymer further contains about 0.1 to about 5 weight percent of repeating units arising from non-perfluorinated monomers other than FG.

In one embodiment, the FG-fluoropolymer further contains about 1 weight percent or less of repeating units arising from non-perfluorinated monomers other than FG.

### 11. Process for the Manufacturing of FG-Fluoropolymer

In one embodiment, FG-fluoropolymer can be manufactured by known processes, such as polymerization in supercritical carbon dioxide as disclosed in U.S. Pat. No. 6,107,423.

In another embodiment, FG-fluoropolymer can be manufactured by an aqueous dispersion polymerization process such as described in present examples 2 and 3.

### 12. FG-Fluoropolymer Utility

FG-fluoropolymer has utility as adhesive for adhering perfluoropolymer (e.g., PTFE, FEP, PFA) and polymer, metal or inorganic substrates. Perfluoropolymer strongly adheres to FG-fluoropolymer, and FG-fluoropolymer strongly adheres to many polymers, metals and inorganics.

In one embodiment, FG-fluoropolymer can be used to adhere perfluoropolymer and thermoplastic having amine functionality in an article such as a perfluoropolymer-lined polyamide tube of utility for petroleum fuel service. In order to form such an article, a layer of FG-fluoropolymer can be melt extruded as an interlayer between a melt extruded layer of perfluoropolymer and a melt extruded layer of polyamide.

In one embodiment, a substrate contains functional groups (e.g., amine) that react with or otherwise strongly associate with the carboxyl groups of the FG-fluoropolymer, resulting in strong adhesion between the FG-fluoropolymer and such a substrate.

In another embodiment, FG-fluoropolymer aqueous dispersion can be blended with another polymer aqueous dispersion, then the dispersion blended polymer isolated and used, for example, as adhesive. In another embodiment, FG-fluoropolymer can be melt blended with another polymer, and the resultant melt blend used, for example, as adhesive. Included herein is a composition comprising a melt-blended mixture comprising FG-fluoropolymer and another polymer.

In another embodiment FG-fluoropolymer is coextruded as an adhesive layer between two other polymer layers to be adhered.

The use of FG-fluoropolymer as adhesive can be accomplished as is known in the art for other kinds of polymers which accomplish the same end using similar methods. For instance, melt mixing of polymers using equipment such as screw extruders is known. Similarly multi-layer film extrusion, including the use of adhesive or tie layers is also known.

### 13. Multi-Layer Article

Included herein is a multi-layer article having a layer comprising FG-fluoropolymer. In one embodiment, the multi-layer article is a laminate comprising a sheet of material made of at least two different bonded layers. In another embodiment, the multi-layer article comprises: (A) a first layer comprising at least one material selected from the group consisting of non-fluorinated polymer having polar functionality, metal and inorganic, and; (B) a second layer comprising FG-fluoropolymer, wherein (A) and (B) are in contiguous contact.

In one embodiment, the multi-layer article is a multi-layer tube having at least one layer comprising FG-fluoropolymer. In another embodiment, the multi-layer article is an insulated wire having at least one layer comprising FG-fluoropolymer. In another embodiment, the multi-layer article is a melt extrusion die having a flow passage coated with FG-fluoropolymer. In another embodiment, the multi-layer article is an electronic device having at least one layer comprising FG-fluoropolymer. In another embodiment, the multi-layer article is an optical fiber having at least one layer comprising FG-fluoropolymer.

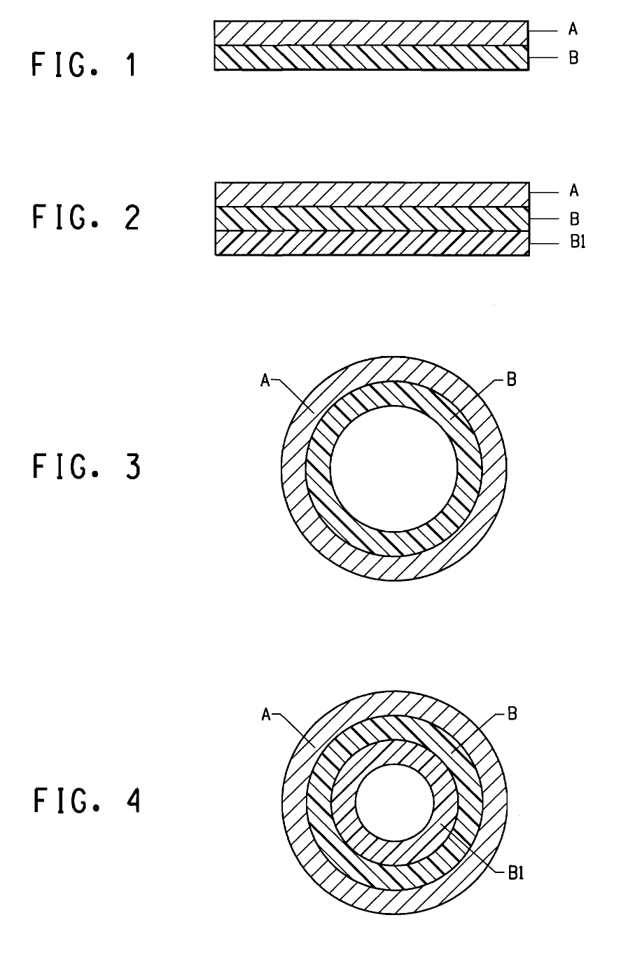

FIG. 1 illustrates a cross-sectional view of one embodiment of the present invention being a multi-layer article having two layers comprising: (A) a first layer comprising at least one material selected from the group consisting of non-fluorinated polymer having polar functionality, metal and inorganic; and (B) a second layer comprising FG-fluoropolymer. One face of second layer (B) is in contiguous contact with one face of first layer (A).

FIG. 2 illustrates a cross-sectional view of one embodiment of the present invention being a multi-layer article having three layers comprising: (A) a first layer comprising at least one material selected from the group consisting of non-fluorinated polymer having polar functionality, metal and inorganic; (B) a second layer comprising FG-fluoropolymer; and (B1) a third layer comprising perfluoropolymer. One face of third layer (B1) is in contiguous contact with the first face of second layer (B), and one face of first layer (A) is in contiguous contact with the second face of second layer (B) which is opposite the first face of second layer (B).

FIG. 3 illustrates a cross-sectional view of one embodiment of the present invention being a multi-layer tube having two layers comprising: a first layer (A) comprising non-fluorinated polymer having polar functionality, and; a second layer (B) comprising FG-fluoropolymer; wherein the layers are arranged concentrically such that first layer (A) is outside of second layer (B). The outer face of second layer (B) is in contiguous contact with the inner face of first layer (A).

FIG. 4 illustrates a cross-sectional view of one embodiment of the present invention being a multi-layer tube having three layers comprising: a first layer (A) comprising non-fluorinated polymer having polar functionality; a second layer (B) comprising FG-fluoropolymer, and; a third layer (B1) comprising a perfluoropolymer; wherein the layers are arranged concentrically such that second layer (B) is outside of third layer (B1) and first layer (A) is outside of second layer (B). The outer face of third layer (B1) is in contiguous contact with the inner face of second layer (B), and the outer face of second layer (B) is in contiguous contact with the inner face of first layer (A).

### 14. Multi-Layer Article First Layer (A)—Non-Fluorinated Polymer Having Polar Functionality

In one embodiment the first layer (A) comprises a non-fluorinated polymer having polar functionality. The polar functionality is at least one selected from the group consisting of amine, amide, imide, nitrile, urethane, chloride, ether, ester, hydroxyl, carbonate, and carboxyl. Example non-fluorinated polymer having polar functionality is at least one selected from the group consisting of: EEA (ethylene-ethyl acrylate), EMA (ethylene-methyl acrylate), EVOH (polyethylene-vinyl alcohol copolymers), PA (polyamide), PET (polyethylene terephthalate), Pi (polyimide), PMMA (polymethyl methacrylate), PVA (polyvinyl acetate), PVAL (polyvinyl alcohol), polycarbonate (PC), polyvinyl butyral (PVB), polyurethane (PU), polyacrylonitrile (PAN), and PVC (polyvinyl chloride).

### 15. Multi-Layer Article First Layer (A)—Thermoplastic Having Amine Functionality

In one embodiment the non-fluorinated polymer of first layer (A) comprises a thermoplastic having amine functionality. Thermoplastics having amine functionality of utility have: (i) a relative viscosity (rV) of about 50 or less as measured by ASTM D789, and; (ii) about 10 or greater, preferably 20 or greater, meq amine ends per kg of thermoplastic having amine functionality. Amine ends are as defined in the “Nylon Plastics Handbook” by Melvin L. Kohan, and can be determined by known methodology, such as by titration with perchloric acid.

Examples of thermoplastic having amine functionality include at least one selected from the group consisting of: polyamide, poly(ethyleneimine) (PEI), polyallylamine, polyvinylamine, polyvinylpyridine, polydiallyldimethylammonium chloride, and polyoxymethylene compositions containing amine polymer having pendant amine functional groups as disclosed in U.S. Pat. No. 5,128,405.

Representative thermoplastic polyamides are melt extrudable and generally have a number average molecular weight of at least about 5,000. Example polyamides include those made by condensation of equimolar amounts of at least one saturated dicarboxylic acid containing 4 to 14 carbon atoms with at least one diamine containing 4 to 14 carbon atoms. Excess diamine, however, can be used to provide an excess of amine end groups over carboxyl end groups in the polyamide. Specific examples include polyhexamethylene adipamide (66 nylon), polyhexamethylene azelaamide (69 nylon), polyhexamethylene sebacamide (610 nylon), polyhexamethylene dodecanoamide (612 nylon) and polycaprolactam (6 nylon). Aromatic polyamides that are melt extrudable (e.g., aliphatic-aromatic polyamides, as opposed to polyaramids) are of utility. Examples of such semi aromatic polyamides include Amodel® A 1000 and copolymers of 2-methylpentamethylenediamineterephthalate and hexamethyleneterephthalamide such as Zytel® HTN 501 (manufactured by E. I. du Pont de Nemours & Co., Wilmington, Del.). Elastomer-modified versions of such aliphatic and aromatic polyamides are also of utility, e.g., Amodel® ET 1000 HSNT (Amoco). Polyamides are polymers that are well-known in the art. See, for example, Kirk-Othmer, Encyclopedia of Chemical Technology, 4th ed., Vol. 19, p. 454 (1996).

### 16. Multi-Layer Article First Layer (A)—Metal

In one embodiment the first layer (A) comprises at least one metal selected from the group consisting of metals of groups IB, IIB, IIIB, IVB, VB, VIB, VIIB, VIIIB, IIIA and IVA of the periodic table of the elements. These metals include lithium, beryllium, sodium, magnesium, aluminum, potassium, calcium, scandium, titanium, vanadium, chromium, manganese, iron, cobalt, nickel, copper, zinc, gallium, rubidium, strontium, yttrium, zirconium, niobium, molybdenum, technetium, ruthenium, rhodium, palladium, silver, cadmium, indium, tin, antimony, caesium, barium, lanthanum, hafnium, tantalum, tungsten, rhenium, osmium, iridium, platinum, gold, mercury, thallium, lead, and bismuth. In an embodiment of the present invention, the metal is at least one metal selected from the group consisting of aluminum, chromium, cobalt, copper, iron, manganese, molybdenum, nickel, niobium, rhenium, steel, tantalum, titanium, tungsten, and zirconium. In another embodiment, the metal includes mixtures of the aforementioned, including alloys, for example, Inconel® and Hastelloy®.

In another embodiment, the metals further contain nonmetals. An example of this embodiment is steel comprising iron and carbon.

### 17. Multi-Layer Article First Layer (A)—Inorganic

In one embodiment the first layer (A) comprises inorganic. By inorganic, or inorganic substrate, is meant materials that do not contain carbon as the principal element, excepting carbonates, carbides, cyanides, and cyanates. Example inorganic substrates are synthetic compounds, and natural minerals and rocks, comprising silicates, carbonates, sulfates, halides, oxides or sulfides. Example inorganic substrates include glass, perlite, gypsum, vermiculite, zeolite, ceramics, clay, cement, concrete, mortar, stone, brick, silica, phosphates, alumina, sodium chloride and calcium carbonate.

### 18. Multi-Layer Article Optional Third Layer (B1)—Perfluoropolymer

Perfluoropolymers of utility are melt extrudable. In one embodiment, perfluoropolymers have a melt viscosity in the range of 0.5×10³ to 60×10³ Pa·s as normally measured for the particular perfluoropolymer. Perfluoropolymers are made by polymerization of at least one perfluorinated monomer by known methods. Perfluoropolymers include copolymers of tetrafluoroethylene (TFE) with one or more polymerizable perfluorinated comonomers, such as perfluoroolefin having 3 to 8 carbon atoms (e.g., hexafluoropropylene (HFP)) and/or perfluoro(alkyl vinyl ether) (PAVE) in which the perfluoroalkyl group contains 1 to 5 carbon atoms and is linear or branched. PAVE monomers of utility can be represented by the formula CF₂═CFOR or CF₂═CFOR′OR, wherein R is perfluorinated linear or branched alkyl groups having 1 to 5 carbon atoms, and R′ is perfluorinated linear or branched alkylene groups having 1 to 5 carbon atoms. In another embodiment, R groups have 1 to 4 carbon atoms. In another embodiment, R′ groups have 2 to 4 carbon atoms. In another embodiment, PAVE monomers include perfluoro(methyl vinyl ether) (PMVE), perfluoro(ethyl vinyl ether) (PEVE), perfluoro(propyl vinyl ether) (PPVE), and perfluoro(butyl vinyl ether) (PBVE). The copolymer can be made using several PAVE monomers, such as the TFE/PMVE/PPVE copolymer, sometimes called MFA by the manufacturer.

In another embodiment, perfluoropolymers include TFE/HFP copolymer in which the HFP content is about 5-17 weight percent. In another embodiment, perfluoropolymer is TFE/HFP/PAVE where the PAVE is PEVE or PPVE, and where the HFP content is about 5-17 weight percent and the PAVE content is about 0.2 to 4 weight percent, the balance being TFE, to total 100 weight percent for the copolymer. The TFE/HFP copolymers, whether or not a third comonomer is present, are commonly known as FEP. In another embodiment, perfluoropolymer is TFE/PAVE copolymer, commonly known as PFA, having at least about 2 weight percent PAVE of the total weight per cent, including when the PAVE is PPVE or PEVE, and typically contain about 2-15 weight percent PAVE. In another embodiment, PAVE in perfluoropolymer includes PMVE, the composition is about 0.5-13 weight percent perfluoro(methyl vinyl ether) and about 0.5 to 3 weight percent PPVE, the remainder of the total of 100 weight percent being TFE, and as stated above, may be referred to as MFA.

Examples of commercially available perfluoropolymers of utility include Teflon® FEP grades 100, TE9494, and 100J, and Teflon® PFA grade 340n (all of these perfluoropolymers are manufactured by E. I. du Pont de Nemours & Co., Wilmington, Del.)

### 19. Thickness of Multi-Layer Article Layers

The thickness of each of the layers comprising the multi-layer article is not limited, and can be determined by one of ordinary skill in this field without undue experimentation based on the type of application for which the article is intended to be used.

The present multi-layer articles can be in many sizes and configurations. The first layer (A) can be thick or thin, rigid or flexible, flat or contoured, and so on. The first layer (A) can be a rigid sheet, a flexible sheet, or a structure such as a vessel (e.g., tank) or pipe, a fiber, an electronic device (e.g., printed circuit board) and the like.

In another embodiment where the multi-layer tubing will be used in fuel service, the inner diameter of the tubing can range from about 3 to about 20 mm and the thickness of the tubing wall can range from about 0.5 to about 2 mm.

In another embodiment where the multi-layer tubing will be used in fuel service, and the multi-layer tubing comprises a first layer (A) comprising a non-fluorinated polymer having polar functionality, a second layer (B) comprising FG-fluoropolymer, and a third layer (B1) comprising perfluoropolymer, the (B1) layer can be from about 0.05 mm to about 0.5 mm thick, the (B) layer can be from about 0.05 mm to about 0.5 mm thick, and the (A) layer can be from about 0.05 mm thick to about 1.5 mm thick.

### 20. Method of Manufacturing of Multi-Layer Article

In one embodiment, the multi-layer article can be manufactured by a process comprising lamination of a sheet of the first layer (A) and a sheet of the second layer (B) comprising FG-fluoropolymer.

In another embodiment, the multi-layer article can be manufactured by a process comprising vapor depositing first layer (A) on to a sheet of the second layer (B) comprising FG-fluoropolymer.

In another embodiment, the multi-layer article can be manufactured by a process comprising electrostatically powder coating the FG-fluoropolymer onto the substrate (e.g., non-fluorinated polymer having polar functionality, metal or inorganic) to form a powder coated substrate, and heating the powder coated substrate to form the multi-layer article.

In another embodiment, the multi-layer article can be manufactured by a process comprising powder dispersed liquid coating the FG-fluoropolymer onto a substrate (e.g., non-fluorinated polymer having polar functionality, metal or inorganic), and heating the liquid coated substrate to form said multi-layer article. A known process of powder dispersed liquid coating can be used, in this embodiment, such as that disclosed in EP Patent No. 0789728 B1 to Hagiwara et al.

In another embodiment, the multi-layer article can be manufactured by a process comprising aqueous dispersion coating the FG-fluoropolymer onto a substrate (e.g., non-fluorinated polymer having polar functionality, metal or inorganic), and heating the dispersion coated substrate to form said multi-layer article. A known process of aqueous dispersion coating process can be used, in this embodiment, such as that disclosed in U.S. Pat. No. 3,925, 292 to Holmes.

In another embodiment, the multi-layer article can be manufactured by a process comprising rotolining the FG-fluoropolymer onto the substrate (e.g., non-fluorinated polymer having polar functionality, metal or inorganic), and heating said rotolined substrate to form said multi-layer article. A known rotolining process can be used in this embodiment, such as that disclosed in U.S. Pat. No. 6,287,632 to Nishio et al.

In another embodiment, the multi-layer article can be formed by sheet extrusion, followed by pressing the sheeting together at an elevated temperature to form a laminate. Such laminate can be then shaped by known methods into various shapes of commercial utility such as a: hose, pipe, tube, sheet, seal, gasket, packing, film, tank, roller, bottle and container.

In another embodiment, the second layer (B) comprising FG-fluoropolymer, as well as optional third layer (B1) comprising perfluoropolymer, can be coextruded on to the first layer (A) comprising metal, resulting in contiguous contact between the first layer (A) comprising metal and the second layer (B) comprising FG-fluoropolymer, and thereby adhering first layer (A) and second layer (B) in sufficiently permanent laminar adhesion and, for example, formation of an insulated wire.

In another embodiment, the multi-layer article can be formed by sheet extrusion to form sheeting of layers (A) and (B), and optionally layer (B1), followed by pressing the sheeting together at an elevated temperature to form a laminate. Such laminate can be then shaped by known methods into various shapes of commercial utility such as a: hose, pipe, tube, sheet, seal, gasket, packing, film, tank, roller, bottle and container.

In another embodiment, the first layer (A) comprising non-fluorinated polymer having polar functionality, and the second layer (B) comprising FG-fluoropolymer, as well as optional third layer (B1) comprising perfluoropolymer, can be coextruded resulting in contiguous contact between layer (A) and layer (B), and layer (B) and layer (B1), thereby adhering layer (A) and layer (B) in sufficiently permanent laminar adhesion and formation of a layered tube.

As will be recognized by one of ordinary skill in this art, such sufficiently permanent laminar adhesion can depend on extrusion conditions as well as on the specific constitution of the materials comprising the different layers. Such conditions can include temperature, extrusion speed, draw down ratio, draw ratio balance, interfacial pressure, cooling rate, cooling conditions (such as maintenance of pressure during cooling), and the like, and can be influenced by equipment choices such as mandrel length, die design features including land length, and the like.

In one embodiment, sufficiently permanent laminar adhesion resulting in adhesion of layer (A) and layer (B) is meant that, for a multi-layer article comprising layer (A) and layer (B) (e.g., formed by coextrusion), layer (A) and layer (B) adhere to one another such that delamination does not occur below the yield strength of layer (A) and/or layer (B).

In the embodiment where first layer (A) comprises metal, by sufficiently permanent laminar adhesion resulting in adhesion of first layer (A) comprising metal and second layer (B) comprising FG-fluoropolymer is meant that, for a multi-layer article comprising metal and FG-fluoropolymer, the metal layer and the FG-fluoropolymer layer adhere to one another such that the peel strength of the multi-layer article is greater than about 50 g/in.

### Examples

The concepts described herein will be further described in the following examples, which do not limit the scope of the invention described in the claims.

### Example 1

### FG-Fluoropolymer Comprising TFE, HFP, PMVE and Maleic Anhydride

### FG-Fluoropolymer Preparation

This example illustrates the preparation of a FG-fluoropolymer comprising repeating units arising from TFE, HFP, PMVE and maleic anhydride by a continuous process.

The reaction system is configured as described in FIG. 1 of U.S. Pat. No. 6,051,682 with the following additions. A high pressure piston pump is configured to allow precise pumping of liquid directly to the vertical stirred autoclave. The fluid pumped is a mixture of solvent and dissolved maleic anhydride. Any fluid which is capable of dissolving maleic anhydride and is not excessively telogenic is suitable for this purpose. Such solvents include, but are not limited to, ethyl acetate, acetone and glacial acetic acid. In this example, the maleic anhydride mixture consists of 20 grams of maleic anhydride dissolved in 100 grams of ethyl acetate.

A vertical stirred autoclave and all associated feed, filtration and recycle systems are flushed with pure CO₂ to remove all moisture and air. Monomer feed flows are set so that the composition is roughly equal to the composition exiting the reactor during steady state operation. The weight ratio of monomer and CO₂ to TFE are as follows: CO₂/TFE=0.95 to 1.0, HFP/TFE=4.7 to 4.8 and PMVE/TFE=0.75 to 0.8. TFE content in this mixture is approximately 13.2 wt %. The reactor contents are heated to an operating temperature of 65° C. and the reactor is elevated to an operating pressure of 8.3 MPa by addition of this monomer mixture. Once at operating pressure, flow of reactor contents through the reactor exit is started and sent through the filtration system and recycled back to the feed system. Reactor effluent is controlled so that the residence time of material in the reactor is approximately 45 minutes. Reactor pressure is controlled by monomer feed flow rate to the reactor. Initiator used for this polymerization is a nominal 10 wt % mixture of HFPO dimer peroxide (CF₃CF₂CF₂OCF(CF₃)(C═O)OO(C═O)(CF₃)CFOCF₂CF₂CF₃, for example manufactured by the process of U.S. Pat. No. 6,395,937) in Vertrel® XF (2,3-dihydroperfluoropentane, available from E. I. du Pont de Nemours). Reaction is started by injecting a precharge of 5 ml initiator solution per liter of reactor volume and reaction is maintained by a continuous injection of 4 ml/hr initiator solution per liter of reactor volume. Once initiator flow is started, the feed composition is shifted so that the weight ratio of monomers and CO₂ to TFE are as follows: CO₂/TFE=0.5, HFP/TFE=2.9 to 3.0, PMVE/TFE=0.47 to 0.48. TFE content in this mixture is approximately 20.2 wt %. At the time that initiator flow is started, pumping of maleic anhydride solution to the reactor is also started at a rate of 0.5 ml/hr per liter of reactor volume. When polymerization reaches steady state, FG-fluoropolymer is produced at a rate of 85 to 100 grams/hr per liter of reactor volume. FG-fluoropolymer viscosity is controlled by varying initiator flow rate.

The FG-fluoropolymer produced has a melting point of 245° C. as measured by Differential Scanning Calorimeter (DSC). The polymer composition measured by FTIR has a HFP content of 5.3 wt %, a PMVE content of 6.3 wt % and a maleic anhydride content of 0.035 wt %. MFR determined by ASTM method D1238-04c at 297° C. with a 5 kg weight is a 22 g/10 minutes.

### Properties

### A) Fuel Vapor Transmission Rate

Circular samples having a minimum diameter of 36 mm were cut from films having a nominal thickness of 0.35 mm and used for permeation testing. The permeation data was obtained using the procedure described in SAE J2659-03, Test Method to measure Fluid Permeation of Polymeric Materials by Speciation, with the following details:

The permeation test cell featured two fuel cups made of glass and separated by the test film. The test film was mounted between the two cups using two O-ring type gaskets made of fluoroelastomer encapsulated in fluoropolymer film and placed in grooves in the fuel cup flange.

The test liquid was CE 10 fuel (10 wt % ethanol, 45 wt % iso-octane, 45 wt % toluene) placed in the bottom cup with a vapor space below the film. (See earlier section 6 regarding FG-fluoropolymer Fuel Vapor Transmission Rate.) The test cell was placed in a chamber controlled at 40° C. plus or minus 1° C. A conditioning time period varying from 103 to 122 days was taken to insure that samples were at equilibrium with the fuel before the permeation measurements were started. The variation in conditioning time period was dependant on the film material and the film thickness. A conditioning time period was taken to allow the films to reach a steady state or constant flux rate before beginning the permeation measurements. The CE10 fuel was refreshed during the conditioning period to maintain the fuel composition. (The conditioning time was determined when the permeate species flux rates were constant. Flux rates are affected by film thickness and the polymer type so each film can require a different conditioning time. Duplicate samples were placed into CE10 fuel@40 C conditioning. The conditioning times for the duplicate samples are shown in Table 1 below.)

A HP 5890 model gas chromatographic apparatus, made by Hewlett Packard, was used to separate and analyze the various constituents of the fuel in the purge gas.

The steady state flux of each fuel constituent was determined by sampling of the permeate/purge gas mixture and the total flux permeating the film was obtained by summing the contributions from all of the different fuel constituents. The vapor transmission rate, VTR, was obtained by multiplying the thickness of the film with the steady state flux.

The samples were measured in duplicate and the individual constituent and total vapor transmission rates are reported in Table 1 below as the average of the two measurements.

TABLE 1

| | Film | Vapor Transmission Rate, gm- | | | | |
|---|---|---|---|---|---|---|
| | Thick- | mm/m²-day | | | | |
| | ness, | | Iso- | | Total | Conditioning |
| Sample | Mm | ETOH | Octane | Toluene | Fuel | Time, Days |
| Tefzel ® | 0.328 | 0.2630 | 0.0020 | 0.2615 | 0.5265 | 107, 122 |
| 200 | | | | | | |
| PFA 345 | 0.373 | 0.0375 | 0.0015 | 0.1050 | 0.1440 | 109, 111 |
| FEP | 0.288 | 0.0135 | 0.0004 | 0.0348 | 0.0487 | 103, 104 |
| TE9494 | | | | | | |
| Example | 0.329 | 0.0150 | 0.0008 | 0.0215 | 0.0373 | 117, 121 |
| 1 FG- | | | | | | |
| fluoro- | | | | | | |
| polymer | | | | | | |

### B) Adhesion Results for Coextruded Tubing/Laminates

One-inch wide strips were cut from co-extruded tube constructions in the longitudinal direction. The layers were separated or attempted to be separated at the layer interface and pulled in a tensile tester at room temperature and 50% humidity in a “T-peel” configuration at a separation speed of 12 inches/minute (about 30 cm/min). The average force to separate the layers was divided by the width of the strip to give the peel strength reported in g/inch. Three or five separate determinations were made and reported as an average. If the layers could not be separated to start the test, then the result is reported as “CNS” or “Can not separate” and indicates the highest level of adhesive bond. A peel strength value higher than 680 g/inch is considered adhesive. The results in Table 2 show the polymer composition of Example 1 has excellent adhesion (i.e. peel strength) to thermoplastics with amine functionality such as polyamide or DuPont® ETPV EX23.

TABLE 2

| | | Average Peel Strength, |
|---|---|---|
| Layer 1 | Layer 2 | g/inch |
| Example 1 FG- | PA12 | Can Not Separate |
| fluoropolymer | | |
| Example 1 FG- | DuPont ® ETPV EX23 | 3,391 |
| fluoropolymer | | |

The results in Table 3 below show the polymer composition of Example 2A has good adhesion (i.e. peel strength) to thermoplastics with amine functionality such as polyamide.

TABLE 3

| | | Average Peel Strength, |
|---|---|---|
| Layer 1 | Layer 2 | g/inch |
| Example 2A FG- | PA12 | 721 |
| fluoropolymer | | |

The results in Table 4 show the polymer compositions of Example 3 (A-E) have good adhesion (i.e. peel strength) to thermoplastics with amine functionality such as polyamide.

TABLE 4

| | | Average Peel Strength, |
|---|---|---|
| Layer 1 | Layer 2 | g/inch |
| Example 3A FG- | PA12 | 1,822 |
| fluoropolymer | | |
| Example 3B FG- | PA12 | 1,066 |
| fluoropolymer | | |
| Example 3C FG- | PA12 | 1,271 |
| fluoropolymer | | |
| Example 3D FG- | PA12 | 1,198 |
| fluoropolymer | | |
| Example 3E FG- | PA12 | 1,636 |
| fluoropolymer | | |

### Example 2

### FG-Fluoropolymer Comprising TFE, HFP, PEVE and Itaconic Acid

### FG-Fluoropolymer Preparation

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 330 mL of a 20 wt % solution of ammonium perfluorooctanoate surfactant in water, and 5 grams of Krytox® 157 FSL perfluoropolymer carboxylic acid. With the reactor paddle agitated at 46 rpm, the reactor was heated to 60° C., evacuated and purged three times with TFE. The reactor temperature then was increased to 103° C. After the temperature had become steady at 103° C., HFP was added slowly to the reactor until the pressure was 444 psig (3.16 MPa). Ninety-two mL of liquid PEVE was injected into the reactor. Then TFE was added to the reactor to achieve a final pressure of 645 psig (4.55 MPa). Then 40 mL of freshly prepared aqueous initiator solution containing 1.63 wt % ammonium persulfate (APS) was charged into the reactor. Then, this same initiator solution was pumped into the reactor at 10 mL/min for the remainder of the polymerization. After polymerization had begun as indicated by a 10 psi (70 KPa) drop in reactor pressure, additional TFE was added to the reactor at a rate of 24.5 pound (11.1 kg)/125 minutes. Furthermore, liquid PEVE was added at a rate of 1.0 mL/min for the duration of the reaction. After 1 pound (0.45 kg) of TFE had been fed after the onset of polymerization, an aqueous solution of 1 wt % itaconic acid (ITA) was started at 5 mL/minute and continued for the remainder of the batch. After 24.4 pounds (11.1 kg) of TFE had been injected over a reaction period of 125 minutes, the reaction was terminated. At the end of the reaction period, the TFE feed, PEVE feed, and the initiator feed were stopped, and the reactor was cooled while maintaining agitation. When the temperature of the reactor contents reached 90° C., the reactor was slowly vented. After venting to nearly atmospheric pressure, the reactor was purged with nitrogen to remove residual monomer. Upon further cooling, the dispersion was discharged from the reactor at below 70° C. After coagulation, the polymer was isolated by filtering and then drying in a 150° C. convection air oven. The polymer had a melt flow rate determined by ASTM method D1238-04c at 372° C. with a 5 kg weight of 34.7 g/10 minutes, a melting point of 234° C. and HFP content of 13.9 wt %, a PEVE content of 1.69 wt %, and an itaconic acid content of 0.05 wt %.

Four FG-fluoropolymer samples were prepared by the above procedure, except that the injection rate of itaconic acid (ITA) was varied from sample to sample to achieve a different weight percent ITA as shown in Table 5.

TABLE 5

| | | | | Melting | |
|---|---|---|---|---|---|
| | WT % | WT % | | Point | WT % |
| EXAMPLE | HFP | PEVE | MFR | (° C.) | ITA |
| 2A | 13.90 | 1.69 | 34.7 | 234 | 0.05 |
| 2B | 14.94 | 1.75 | 64.5 | 225 | 0.02 |
| 2C | 15.87 | 1.73 | 62.5 | 219 | 0.01 |
| 2D | 15.96 | 1.73 | 68.7 | 218 | 0.005 |

### Example 3

### FG-Fluoropolymer: TFE/HFP/PEVE/Mesaconic Acid

### FG-Fluoropolymer Preparation

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 500 mL of 0.1 N nitric acid, 260 mL of a 20 wt % solution of ammonium perfluorooctanoate surfactant in water, and 2 grams of Krytox® 157 FSL perfluoropolymer carboxylic acid. With the reactor paddle agitated at 46 rpm, the reactor was heated to 60° C., evacuated and purged three times with TFE. The reactor temperature then was increased to 103° C. After the temperature had become steady at 103° C., HFP was added slowly to the reactor until the pressure was 444 psig (3.16 MPa). Ninety-two mL of liquid PEVE was injected into the reactor. Then TFE was added to the reactor to achieve a final pressure of 645 psig (4.55 MPa). Then 50 mL of freshly prepared aqueous initiator solution containing 2.38 wt % ammonium persulfate (APS) was charged into the reactor. Then, this same initiator solution was pumped into the reactor at 10 mL/min for the remainder of the polymerization. After polymerization had begun as indicated by a 10 psi (70 KPa) drop in reactor pressure, additional TFE was added to the reactor at a rate of 15 pound (6.8 kg)/125 minutes. Furthermore, liquid PEVE was added at a rate of 1.0 mL/min for the duration of the reaction. After 1 pound (0.45 kg) of TFE had been fed after the onset of polymerization, an aqueous solution of 1 wt % mesaconic acid (MAS) was started at 5 mL/minute and continued for the remainder of the batch. After 15 pounds (6.8 kg) of TFE had been injected over a reaction period of 125 minutes, the reaction was terminated. At the end of the reaction period, the TFE, PEVE, initiator solution and mesaconic acid solution feeds were stopped, and the reactor was cooled while maintaining agitation. When the temperature of the reactor contents reached 90° C., the reactor was slowly vented. After venting to nearly atmospheric pressure, the reactor was purged with nitrogen to remove residual monomer. Upon further cooling, the dispersion was discharged from the reactor at below 70° C. After coagulation, the polymer was isolated by filtering and then drying in a 150° C. convection air oven. The polymer had a melt flow rate determined by ASTM method D1238-04c at 372° C. with a 5 kg weight of 79.6 g/10 minutes, a melting point of 224° C., an HFP content of 16.5 wt %, a PEVE content of 1.19 wt %, and a mesaconic acid content of 0.031 wt %.

Four FG-fluoropolymer samples were prepared by the above procedure, except that the feed rate of TFE was varied from about 36 to about 76 g/min by adjusting the TFE pressure to achieve the results shown in Table 6.

TABLE 6

| | TFE | | | | Melting | |
|---|---|---|---|---|---|---|
| | Rate | WT % | WT % | | Point | WT % |
| EXAMPLE | (g/min) | HFP | PEVE | MFR | (° C.) | MSA |
| 3A | 36.3 | 16.5 | 1.19 | 79.6 | 224 | 0.031 |
| 3B | 54.4 | 12.6 | 1.20 | 138 | 263 | 0.032 |
| 3C | 52.3 | 14.5 | 0.92 | 216 | 243 | 0.032 |
| 3D | 64.8 | 12.5 | 0.60 | 97.8 | 257 | 0.033 |
| 3E | 76.2 | 12.8 | 0.95 | 88.2 | 234 | 0.032 |

### Example 4

### Adhesion of Example 1 FG-Fluoropolymer to Kapton®

The adhesion of example 1 FG-fluoropolymer (comprising repeating units arising from TFE, HFP, PMVE and maleic anhydride) and Kapton® was examined as follows:

An identical amount of pellets of polymer was placed between two 5 cm (2 in) square sheets of polyimide film. The polyimide film containing the polymer pellets was then place between 20 cm (8 in) square metal press plates. The press plates were then placed in a press pre-heated to either 310° C. or 360° C. The press plates were then allowed to sit in the heated press for 3 minutes without applying any pressure. Pressure of 137 MPa (20,000 psi) was then applied to the press plates for 2 minutes. Pressure was then released and the press plates removed from the press and allowed to cool to room temperature. The polyimide film was then peeled apart and the adhesion force estimated on a relative scale of 1 to 10, 10 being the highest relative force required to separate the polyimide film sheets, 1 being the least force required to separate the polyimide film sheets. The results are contained below in Table 7.

TABLE 7

| | FEP | FEP | Example 1 FG- |
|---|---|---|---|
| | TE9494¹ | TE9495¹ | fluoropolymer |
| Relative Force to | 1 | 2 | 10 |
| Separate Kapton ®² | | | |
| polyimide film Pressed at | | | |
| 310° C. | | | |
| Relative Force to | 1 | 3 | 10 |
| Separate Kapton ®² | | | |
| polyimide film Pressed at | | | |
| 360° C. | | | |

¹FEP TE9494 & FEP TE9495: copolymers of tetrafluoroethylene and hexafluoropropylene available from E.I. du Pont de Nemours & Co., Wilmington, DE.
²Kapton ®: polyimide film available from E.I. du Pont de Nemours & Co., Wilmington, DE.

### Example 5

### Adhesion of Example 1 FG-Fluoropolymer to Copper, Aluminum, and Monel®

The adhesion of example 1 FG-fluoropolymer (comprising repeating units arising from TFE, HFP, PMVE and maleic anhydride) and various metals was examined as follows.

An identical amount of pellets of polymer was placed between two 5 cm (2 in) square sheets of metal foil. The metal foil containing the polymer pellets was then place between 20 cm (8 in) square metal press plates. The press plates were then placed in a press pre-heated to either 310° C. or 360° C. The press plates were then allowed to sit in the heated press for 3 minutes without applying any pressure. Pressure of 137 MPa (20,000 psi) was then applied to the press plates for 2 minutes. Pressure was then released and the press plates removed from the press and allowed to cool to room temperature. The metal foil was then peeled apart and the adhesion force estimated on a relative scale of 1 to 9, 9 being the highest relative force required to separate the foil sheets, 1 being the least force required to separate the foil sheets. The results are contained in Table 8:

TABLE 8

| | FEP | FEP | Example 1 FG- |
|---|---|---|---|
| | TE9494¹ | TE9495¹ | fluoropolymer |
| Relative Force to | 2 | 5 | 8 |
| Separate Copper Foil² | | | |
| Pressed at 310° C. | | | |
| Relative Force to | 6 | 9 | 9 |
| Separate Copper Foil² | | | |
| Pressed at 360° C. | | | |
| Relative Force to | 5 | 7 | 9 |
| Separate Aluminum Foil³ | | | |
| Pressed at 310° C. | | | |
| Relative Force to | 3 | 5 | 8 |
| Separate Aluminum Foil³ | | | |
| Pressed at 360° C. | | | |
| Relative Force to | 2 | 5 | 6 |
| Separate Monel Foil⁴ | | | |
| Pressed at 310° C. | | | |
| Relative Force to | 3 | 6 | 6 |
| Separate Monel Foil⁴ | | | |
| Pressed at 360° C. | | | |

¹FEP TE9494 & FEP TE9495: copolymers of tetrafluoroethylene and hexafluoropropylene available from E.I. du Pont de Nemours & Co., Wilmington, DE
²Copper Foil: Puratronic High Purity Research Chemicals and Material, 0.1 mm thick, 99.999% (copper metal basis) stock # 42189, Lot#C31K22.
³Aluminum Foil: Aluminum alloy available from Olin Brass and Winchester (East Alton, IL) containing 81-99 wt % aluminum.
⁴Monel Foil available from Lyon Industries (South Ilgin, IL), 0.025 mm Monel Shim stock.

Example 1 FG-fluoropolymer shows superior adhesion to all tested metals than non FG-containing FEP (tetrafluoroethylene-hexafluoro-propylene) polymers.

### Example 6

### Adhesion of Example 1 FG-Fluoropolymer to Aluminum

The adhesion of example 1 FG-fluoropolymer (comprising repeating units arising from TFE, HFP, PMVE and maleic anhydride) and aluminum was examined as follows.

An 10 cm (4 in) square sheet of identical thickness polymer film was placed between two sheets of 15 cm (10 in) square aluminum foil. The metal foil containing the polymer sheet was then place between metal press plates. The press plates were then placed in a press pre-heated to a chosen temperature. The press plates were then allowed to sit in the heated press for 5 minutes at an applied pressure of 17 MPa (2,500 psi). Pressure was then released and the press plates removed from the press and allowed to cool to room temperature. The metal foil was then peeled apart and the adhesion force estimated on a relative scale of 1 to 4. 1 indicating no adhesion, the sheets readily peel off of polymer, 2 indicating some adhesion, 3 indicating strong adhesion, and 4 indicating that the sheets can not be separated. The results are contained in Table 9:

TABLE 9

Temperature of Press
(° C.)

| | 275 | 290 | 325 | 350 |
|---|---|---|---|---|
| FEP 200C20¹ | — | 1 | 2 | — |
| PFA 200CLP20¹ | — | — | 3 | 3 |
| Example 1 FG- | 3 | 3 | — | — |
| fluoropolymer | | | | |
| Example 1 FG- | 3 | 3 | — | — |
| fluoropolymer, Hand | | | | |
| Corona | | | | |
| FEP 500A¹, Hand | — | 1 | 1 | — |
| Corona | | | | |
| FEP 1000A¹, Hand | — | 2 | 1 | — |
| Corona | | | | |
| PFA 1000LP¹, Hand | — | — | 2 | 2 |
| Corona | | | | |
| PFA 12000LP¹, Hand | — | — | 2 | 2 |
| Corona | | | | |

¹Perfluorinated ethylene-propylene (FEP) and perfluoroalkoxy (PFA) copolymers available from E.I. du Pont de Nemours & Co., Wilmington, DE. The numbers following the FEP or PFA designation relate to the gauge thickness of the films. E.g., FEP 200C20 is a 200 gauge (2 mil) thick film. The “C” following the FEP or PFA designation relates to films that are “cementable”, corona treated in an acetone/nitrogen environment.
²Hand Corona: film was subjected to 6 sweeps in both directions by a hand held corona unit prior to assembly with the aluminum foil and hot pressing.

Example 1 FG-fluoropolymer shows superior adhesion results at much lower temperatures.

### Example 7

### Adhesion of Example 1 FG-Fluoropolymer Powder Coatings to Aluminum, Cold Rolled Steel, and Stainless Steel

Polymers were electrostatically powder coated using a Nordson Versaspray II electrostatic powder spray gun onto prepared metal panels and heated in a hot air convection oven until a smooth coating was obtained. The metal panels were aluminum, cold rolled steel, and stainless steel and were solvent cleaned and ½ grit blasted prior to powder coating. Two trials of heating temperature were carried out, at 274° C. and 288° C., for a period of 15 minutes. The resultant coating thicknesses were from 1.5 to 3.5 mils.

Adhesion of the coatings was tested by the procedure of ASTM D3359 Method B. The coatings were cross-cut before boiling for 15 minutes in water.

Coatings of example 1 FG-fluoropolymer (comprising repeating units arising from TFE, HFP, PMVE and maleic anhydride) gave 5B classification (0% removal) for all metals tested, whether smooth or gritblasted and at both cure temperatures.

Coatings of comparative polymer 532-8000 low melt FEP powder (a perfluorinated ethylene-propylene polymer available from E. I. du Pont de Nemours & Co., Wilmington, Del.) gave adhesion test results or 0B (greater than 65% removal) on the smooth non-gritblasted metals, and an adhesion result of 5B (0% removal) on gritblasted metals. The same result was obtained all metals at both cure temperatures.

Example 1 FG-fluoropolymer shows superior adhesion results to smooth untreated metal surfaces.

### Example 8

### Extrusion Die Hard Coated with Example 1 FG-Fluoropolymer

It is known that molten Teflon® FEP resin will melt fracture during high rate extrusion processes. Melt fracture has also been observed in Teflon® PFA and high molecular weight polyethylene. Melt fracture is an undesirable phenomenon that can be studied with a capillary rheometer.

A Kayeness capillary rheometer, Dynisco model LCR6000, having a Dynisco Y300-20 circular die of 0.03 inch diameter and length-to-diameter ratio of 20, was used to extrude polymer samples.

In one experiment, the die was first cleaned by heating at 570° C. in an ash oven. The sample chamber was cleaned, set at 380° C. and then loaded with example 1 FG-fluoropolymer (comprising repeating units arising from TFE, HFP, PMVE and maleic anhydride). FG-fluoropolymer was passed through the die flow passage until the flow passage was coated with a layer of FG-fluoropolymer. FG-fluoropolymer was then removed from the sample chamber and then the sample chamber was loaded with loaded with FEP TE9494 (perfluorinated ethylene-propylene (FEP) copolymer containing no FG, available from E. I. du Pont de Nemours & Co., Wilmington, Del.). The FEP TE9494 sample was heated in the sample chamber for six minutes. Analysis was conducted over the shear rate range of 13.9 1/s to 1,413 1/s. The extruded strand of FEP TE9494 was collected and examined for melt fracture on the strand surface.

In a comparative experiment, the die was first cleaned by heating at 570° C. in an ash oven. The sample chamber was cleaned, set at 380° C. and then loaded with FEP TE9494 (perfluorinated ethylene-propylene (FEP) copolymer available from E. I. du Pont de Nemours & Co., Wilmington, Del.). The FEP TE9494 sample was heated in the sample chamber for six minutes. Analysis was conducted over the shear rate range of 13.9 1/s to 1,413 1/s. The extruded strand of FEP TE9494 was collected and examined for melt fracture on the strand surface.

Two back-to-back analyses for each experiment were carried out, and conditions under which melt fracture occurred were clearly identifiable. After die pre-treatment with FG-fluoropolymer, the FEP TE9494 extrusion was carried out five times over an interval of 5 hours. It was observed that the melt fracture improvements lasted during that period of time. The results obtained are shown in Table 10.

TABLE 10

| | | Die not coated | Die coated with |
|---|---|---|---|
| | | with example 1 | example 1 FG- |
| Rate (1/s) | Viscosity (Pa · s) | FG-fluoropolymer | fluoropolymer |
| 13.9 | 763.5 | no melt fracture | no melt fracture |
| 166.3 | 586.7 | no melt fracture | no melt fracture |
| 249.4 | 569.1 | melt fracture | no melt fracture |
| 332.6 | 514.0 | melt fracture | no melt fracture |
| 471.2 | 442.7 | melt fracture | no melt fracture |
| 692.9 | 320.5 | melt fracture | no melt fracture |
| 997.7 | 232.2 | melt fracture | melt fracture |
| 1413.5 | 160.4 | melt fracture | melt fracture |

This example demonstrates that a melt extrusion die coated with FG-fluoropolymer allows Teflon® FEP extrudate to endure higher process rates without the formation of melt fracture.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

What is claimed is:

1. A melt processible semicrystalline fluoropolymer comprising:
(a) about 2 to about 20 weight percent of repeating units arising from hexafluoropropylene;
(b) from about 0.001 to about 1 weight percent of repeating units arising from a hydrocarbon monomer having a carboxyl group and a polymerizable carbon-carbon double bond; and
(c) the remaining weight percent of repeating units arising from tetrafluoroethylene.

2. The melt processible semicrystalline fluoropolymer of claim 1, comprising:
(a) about 2 to about 20 weight percent of repeating units arising from hexafluoropropylene;
(b) about 0.001 to about 1 weight percent of repeating units arising from a hydrocarbon monomer having a carboxyl group and a polymerizable carbon-carbon double bond;
(c) about 0.5 to about 10 weight percent of repeating units arising from perfluoro(alkyl vinyl ether); and
(d) the remaining weight percent of repeating units arising from tetrafluoroethylene; wherein the sum of the weight percent of repeating units arising from hexafluoropropylene and the weight percent of repeating units arising from perfluoro(alkyl vinyl ether) is greater than about 4 weight percent and less than about 20 weight percent.

3. The melt processible semicrystalline fluoropolymer of claim 1, comprising:
(a) about 4 to about 14 weight percent of repeating units arising from hexafluoropropylene;
(b) about 0.001 to about 1 weight percent of repeating units arising from a hydrocarbon monomer having a carboxyl group and a polymerizable carbon-carbon double bond and containing a dicarboxylic acid anhydride group or a dicarboxylic acid group;
(c) about 0.5 to about 3 weight percent of repeating units arising from perfluoro(alkyl vinyl ether); and
(d) the remaining weight percent of repeating units arising from tetrafluoroethylene.

4. The melt processible semicrystalline fluoropolymer of claims 1 or 2, wherein said hydrocarbon monomer having a carboxyl group and a polymerizable carbon-carbon double bond contains a dicarboxylic acid anhydride group or a dicarboxylic acid group.

5. A melt-blended mixture comprising a polymer and a melt processible semicrystalline fluoropolymer, wherein said melt processible semicrystalline fluoropolymer comprises:
(a) about 2 to about 20 weight percent of repeating units arising from hexafluoropropylene;
(b) from about 0.001 to about 1 weight percent of repeating units arising from a hydrocarbon monomer having a carboxyl group and a polymerizable carbon-carbon double bond; and
(c) the remaining weight percent of repeating units arising from tetrafluoroethylene.

6. A multi-layer article having a layer comprising a melt processible semicrystalline fluoropolymer, wherein said melt processible semicrystalline fluoropolymer comprises:
(a) about 2 to about 20 weight percent of repeating units arising from hexafluoropropylene;
(b) from about 0.001 to about 1 weight percent of repeating units arising from a hydrocarbon monomer having a carboxyl group and a polymerizable carbon-carbon double bond; and
(c) the remaining weight percent of repeating units arising from tetrafluoroethylene.

7. The multi-layer article of claim 6, comprising a layer of said melt processible semicrystalline fluoropolymer and a layer of substrate, and wherein the material comprising said layer of substrate contains a functional group that associates or bonds with the carboxyl group of said hydrocarbon monomer having a carboxyl group and a polymerizable carbon-carbon double bond.

8. A multi-layer article comprising:
(A) a first layer comprising at least one material selected from the group consisting of non-fluorinated polymer having polar functionality, metal and inorganic, and;
(B) a second layer comprising a melt processible semicrystalline fluoropolymer, wherein said melt processible semicrystalline fluoropolymer comprises:
(a) about 2 to about 20 weight percent of repeating units arising from hexafluoropropylene;
(b) about 0.001 to about 1 weight percent of repeating units arising from a hydrocarbon monomer having a carboxyl group and a polymerizable carbon-carbon double bond; and
(c) the remaining weight percent of repeating units arising from tetrafluoroethylene,
wherein (A) and (B) are in contiguous contact.

9. The multi-layer article of claim 8, wherein said first layer comprises non-fluorinated polymer having polar functionality, and wherein said polar functionality is at least one selected from the group consisting of amine, amide, imide, nitrile, urethane, chloride, ether, ester, hydroxyl, carbonate and carboxyl.

10. The multi-layer article of claim 8, wherein said non-fluorinated polymer having polar functionality is at least one selected from the group consisting of: ethylene-ethyl acrylate; ethylene-methyl acrylate; polyethylene-vinyl alcohol copolymers; polyamide; polyethylene terephthalate; polyimide; polymethyl methacrylate; polyvinyl acetate; polyvinyl alcohol, polycarbonate, polyvinyl butyral, polyurethane, polyacrylonitrile, and polyvinyl chloride.

11. The multi-layer article of claim 8, wherein said first layer comprises metal, and wherein said metal is selected from the group consisting of aluminum, chromium, cobalt, copper, iron, manganese, molybdenum, nickel, niobium, rhenium, steel, tantalum, titanium, tungsten, and zirconium.

12. The multi-layer article of claim 8, wherein said first layer comprise inorganic, and wherein said inorganic is selected from the group consisting of silicates, carbonates, sulfates, halides, oxides and sulfides.

13. The multi-layer article of claim 8, wherein delamination does not occur below the yield strength of said first layer (A) and/or said second layer (B).

14. The multi-layer article of claim 8, wherein said first layer comprises metal, and wherein the peel strength of said multi-layer article is greater than about 50 g/in.

15. The multi-layer article of claim 8, further comprising a third layer (B1) comprising perfluoropolymer, wherein said third layer (B1) is in contiguous contact with said second layer (B).

16. The multi-layer article of claim 8, wherein said multi-layer article is a multi-layer tube comprising:
(A) a first layer comprising said non-fluorinated polymer having polar functionality, and in contiguous contact therewith;
(B) a second layer comprising said melt processible semicrystalline fluoropolymer;
wherein the layers are arranged concentrically such that said first layer (A) is outside of said second layer (B) and the outer face of said second layer (B) is in contiguous contact with the inner face of said first layer (A).

17. The multi-layer article of claim 16, wherein said melt processible semicrystalline fluoropolymer has a CE10 fuel vapor transmission rate at 40° C. as measured by the procedure described in SAE J2659-03 of not greater than about 0.1 g·mm/m²·day.

18. The multi-layer article of claim 16, further comprising a third layer (B1) comprising perfluoropolymer, wherein the layers are arranged concentrically such that said third layer (B1) is inside of said second layer (B), and the outer face of said third layer (B1) is in contiguous contact with the inner face of said second layer (B).

19. The multi-layer article of claim 8, wherein said multi-layer article is an insulated wire comprising:
(A) a wire comprising metal; and
(B) a layer comprising said melt processible semicrystalline fluoropolymer;
wherein (A) and (B) are in contiguous contact.

20. The multi-layer article of claim 8, wherein said multi-layer article is a melt extrusion die comprising metal having a flow passage coated with a composition comprising said melt processible semicrystalline fluoropolymer.

21. The multi-layer article of claim 8, wherein said multi-layer article is an optical fiber comprising:
(A) a fiber comprising an inorganic substrate; and
(B) a layer comprising said melt processible semicrystalline fluoropolymer;
wherein (A) and (B) are in contiguous contact.
